(19) United States
(12) Patent Application Publication
(10) Pub. No.: US 2018/0092505 A1
(43) Pub. Date: Apr. 5, 2018

(54) PORTABLE FLUID DISPENSING AND RINSING SYSTEM

(71) Applicant: Liquid Integrity, LLC, Washington, DC (US)

(72) Inventor: Miguel Nahem SIMON, Washington, DC (US)

(21) Appl. No.: 15/723,748

(22) Filed: Oct. 3, 2017

Related U.S. Application Data
(60) Provisional application No. 62/403,452, filed on Oct. 3, 2016.

(51) Int. Cl. A47L 15/00; B05B 1/18; B05B 9/04; B05B 13/06; B05B 15/06; A47L 15/42; A47L 15/46

(52) U.S. Cl. CPC A47L 15/0065; B05B 1/18; B05B 9/0403; A47L 15/4217; B05B 15/065; A47L 15/4212; A47L 15/46; B05B 13/069

(57) ABSTRACT

The portable fluid dispensing and rinsing system includes a base housing, a drain pan having an outwardly extending circumferential wall forming a drain pan chamber. The circumferential wall has a wall opening and the drain pan includes a nozzle receptacle and a drain opening. The system also includes a switch element, a battery housing, and a motor assembly coupled to the drain pan, a drain plate and a nozzle assembly for seating in the central receptacle of the drain pan. The drain plate is movable in an axial direction between a non-actuated position where the drain plate is separated from the actuator and an actuated position where the drain plate contacts and engages the actuator.

### RELATED APPLICATION

This application claims priority to U.S. provisional patent application Ser. No. 62/403,452, filed on Oct. 3, 2016, entitled Fluid Dispensing Device, the contents of which are hereby incorporated by reference.

### BACKGROUND OF THE INVENTION

The present invention is directed to a fluid dispensing system, and more particularly relates to a portable fluid dispensing and rinsing system for use with fluid receptacles or holders, such as cups or glassware.

As is known in the art. a jockey box is a transportable draft or fluid dispensing system implementing the same theory of a direct draw system that is highly portable and hence can be taken anywhere. The term derives from the transportability of the box or container housing the system components. Most conventional jockey boxes are simply nothing more than large coolers, which are cumbersome, difficult to transport, take up a lot of room and are heavy and difficult to carry.

In conventional jockey boxes, the basic idea is to dispense a selected liquid beverage, such as beer, as you would from a stationary draft system, but instead employ a coil that allows for the chilled or room temperature keg to dispense the beer at a cooler temperature by running the beer through the coil that is chilled by ice. By chilling the beer prior to dispensing, the jockey box allows the system to properly retain CO₂ levels by maintaining the beer cold during dispensing.

The main function and overall importance of this feature is that jockey boxes are most often used for festivals and events where multiple breweries dispense their products. More often than not, a fluid holder, such as a cup or a glass, is provided to the attendee so that they may sample multiple beers. During these types of events, there are either no opportunities for the attendee to clean or rinse out their glass between beers, or the prior art methods for rinsing the glass are rudimentary at best. The ability to rinse the glass prior to use is thus significantly hampered. Prior methods of rinsing the glass include rinsing the glass with the beverage to be sampled, pouring water directly from a water bottle into the glass, and the like. There is currently no suitable, portable fluid dispensing and rinsing system for use in such environments.

### SUMMARY OF THE INVENTION

An object of the present invention is to overcome the above deficiencies by providing for a portable rinsing system for cleaning or rinsing fluid receptacles.

The portable fluid dispensing and rinsing system of the present invention employs a unique ergonomic design that makes transport and set-up extremely easy and user friendly. This design also allows for storage and set up to be less strenuous because of its compact design. The fluid dispensing device can be easily carried and is extremely easy to set up and to use.

The fluid dispensing device of the present invention serves the purpose of allowing for a single glass or fluid holder to be used repeatedly to sample several different products without contamination with residual flavors, thus avoiding the need for a complete wash or new glass at the tasting event. Thus fluid dispensing device allows the consumer to enjoy and taste the beverage free of overlapping flavors and as the producer/seller intended the specific beverage to smell and taste.

The main function and overall importance of the fluid dispensing device is most apparent in the context of festivals or tasting events where multiple vendors dispense their products, each one with a unique beverage. Customers often attend these events specifically for the unique products on offering, with taste being of the upmost importance to their experience. More often than not, a fluid holder, such as a glass, is provided to attendees at these events so that they may sample multiple beverages. Subsequently, there are rarely opportunities for the attendee to clean their glass between beverages, leaving the company representative with the choice of rinsing out the glass with their own product, or more often pouring without a rinse, causing a cross-contamination of flavors. On rare occasions, rinse stations are provided where bottles or coolers are filled with water and the attendee has to attempt to rinse their own glass. These can prove cumbersome and inadequate, do not provide the necessary volume of water to properly clean the glass of residue, and regularly run out of water before the event has come to a close. These rinse stations are often stationary and sparse, and attendees find themselves making multiple trips to attempt to cleanse the glass so that they can enjoy the nuances of each beverage tasted.

The design of the fluid dispensing device of the present invention is unique in its ergonomic design that makes transport and set-up extremely user friendly. Compact in size, the design also allows for easy storage, less strenuous set up, and it can be easily carried using only one hand. Further, many events require multiple products for the same company, and therefore multiple product lines.

The portable fluid dispensing and rinsing system of the present invention includes a base housing having a plurality of sides and forming an inner chamber, wherein a top surface of the base housing has an opening formed therein and a drain pan mounted to the base housing and disposed within the inner chamber. The drain pan has a first surface with an outwardly extending circumferential wall formed thereabout forming a drain pan chamber and an opposed second surface. The circumferential wall has formed therein a wall opening and the first surface of the drain pan includes a nozzle receptacle formed in a generally central location, a fluid passage that is disposed between and is fluidly coupled to the wall opening and to the nozzle receptacle, a plurality of stops protruding outwardly therefrom, each of said plurality of stops is configured for seating a biasing member, and a drain opening.

The system also includes a switch element coupled to the drain pan, a battery housing coupled to the second surface of the drain pan, a motor assembly coupled to the second surface of the drain pan adjacent the battery housing and electrically coupled to the battery housing and to the switch element, a drain plate disposed within the opening in the top surface of the base housing and having a central opening, and a nozzle assembly sized and configured for passing through the central opening of the drain plate and for seating in the central receptacle of the drain pan. The nozzle assembly includes a plurality of nozzle elements formed therein, wherein the nozzle elements are fluidly coupled to the central receptacle, the fluid passage, and the wall opening.

The system of the present invention also includes a switch housing protruding outwardly from the first surface of the drain pan and having an aperture formed therein, wherein the switch element includes an actuator that extends through the aperture in the switch housing.

The drain plate is movable in an axial direction between a non-actuated position where the drain plate is separated from the actuator and an actuated position where the drain plate contacts and engages the actuator. Further, when the drain plate is disposed in the actuated position, the motor assembly is actuated.

The motor assembly includes a motor element and a fluid coupler having an inlet port and an outlet port, a drain connector coupled to the drain opening formed in the drain pan, and a fluid diverter fluidly coupled to the wall opening and to the outlet port of the motor assembly. The drain connector has an elbow shape.

The system of the present invention also includes a first fluid conduit coupled to the inlet port of the motor assembly, a second fluid conduit coupled to the drain connector for draining fluid in the drain pan chamber, and/or a third fluid conduit having one end coupled to the outlet port of the motor assembly and an opposed end coupled to the fluid diverter.

The drain plate is movable in an axial direction between a non-actuated position where the drain plate is separated from the switch element disposed in the switch housing and an actuated position where the drain plate contacts and engages the switch element. Further, when the drain plate is disposed in the actuated position, the motor assembly is actuated and fluid from a fluid source is conveyed through the inlet port of the motor assembly, passes through the outlet port of the motor assembly, passes through the fluid diverter and into the nozzle receptacle via the wall opening and the covered passage, and through the nozzle assembly.

The exemplary embodiments will now be described in detail with reference to the attached drawings.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a perspective view of a portable fluid dispensing and rinsing system of the present invention disposed in a non-actuated position.

FIG. 2 is a perspective view of the portable fluid dispensing and rinsing system of the present invention disposed in an actuated position.

FIG. 3 is an exploded view illustrating selected components of the portable fluid dispensing and rinsing system of the present invention.

FIG. 4 is a perspective view of the motor assembly of the present invention illustrating a fluid coupler having inlet and outlet ports.

FIG. 5 is a bottom perspective view of the drain pan of the present invention.

FIG. 6 is a perspective bottom view of the portable fluid dispensing and rinsing system according to the teachings of the present invention.

FIG. 7 is a partial cross-sectional view of the portable fluid dispensing and rinsing system in the non-actuated position illustrating the various fluid passages therein.

FIG. 8 is a partial cross-sectional view of the portable fluid dispensing and rinsing system in the actuated position illustrating the flow of water through the various fluid passages.

FIG. 9 is a top perspective view of the drain pan of the present invention.

FIG. 10 is a perspective view of a partial assembly of the drain pan, drain plate, and nozzle assembly according to the teachings of the present invention.

FIG. 11 is a perspective view of the drain plate of the portable fluid dispensing and rinsing system of the present invention.

### DETAILED DESCRIPTION

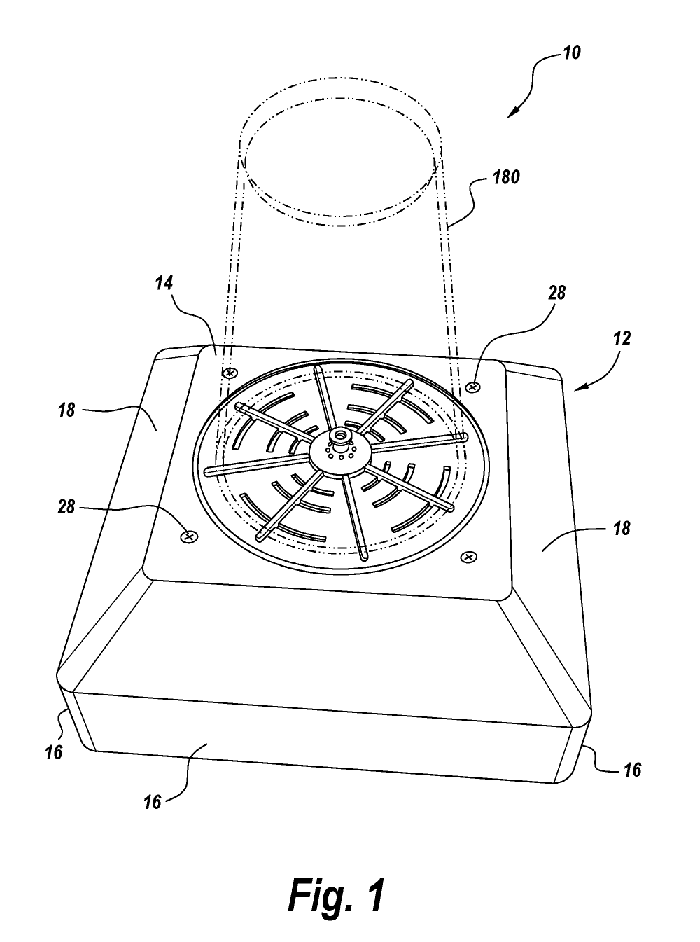

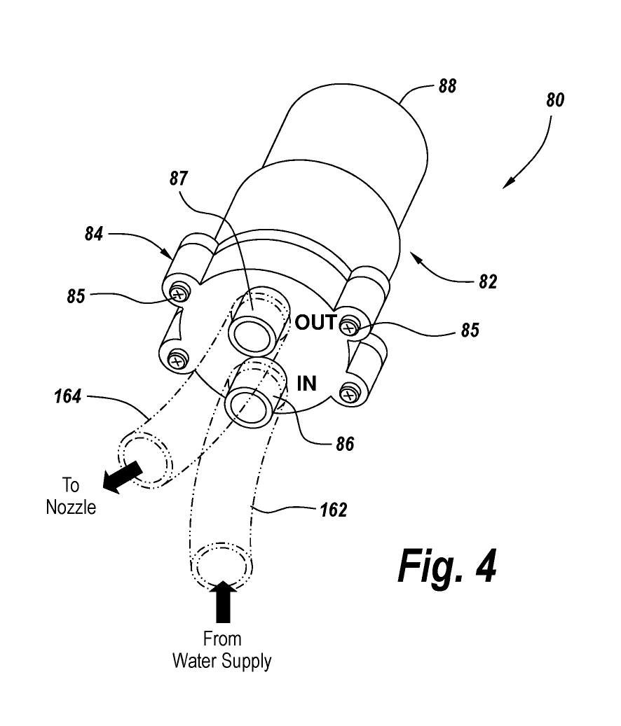

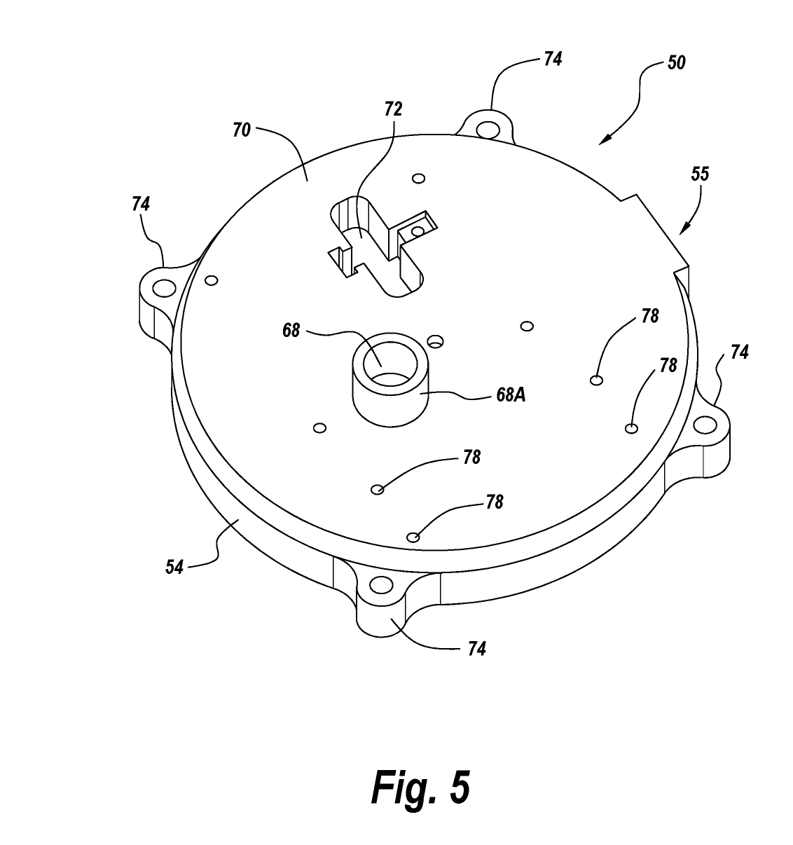

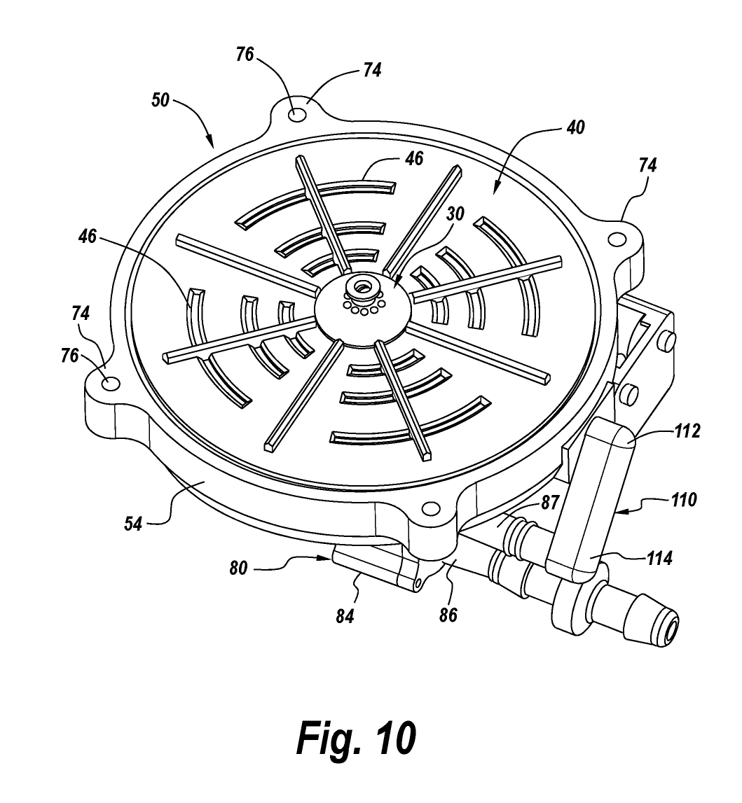

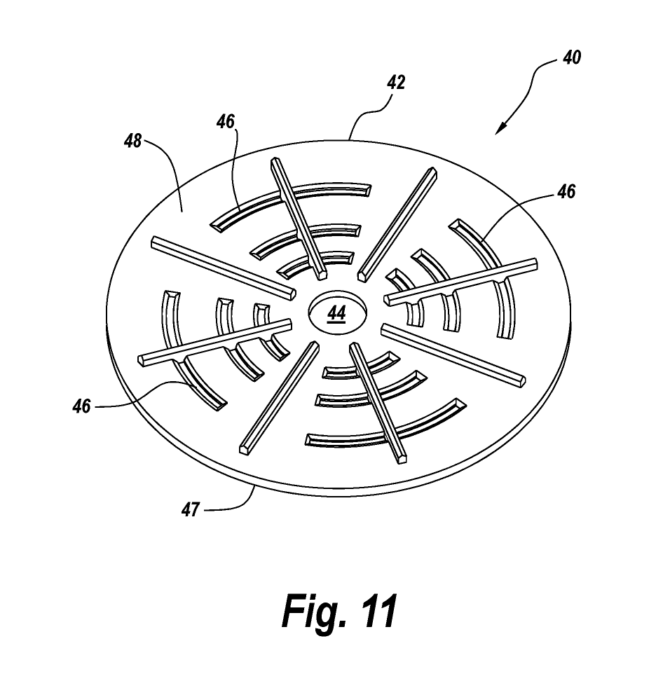

The portable fluid dispensing and rinsing system 10 of the present invention is illustrated in FIGS. 1 through 11. The illustrated portable fluid dispensing and rinsing system 10 includes a base housing 12 that has a top surface 14 having an opening 22, a plurality of side surfaces 16, and a series of sloped surfaces 18 that connect the side surfaces 16 with the top surface 14. The top surface 14 includes a plurality of fastener-receiving apertures 26 for receiving the fasteners 28. The base housing forms a chamber 20 for mounting selected system components therein, as described below. The base housing can have any selected size or shape. For example, the base housing could also take the shape of a box like structure.

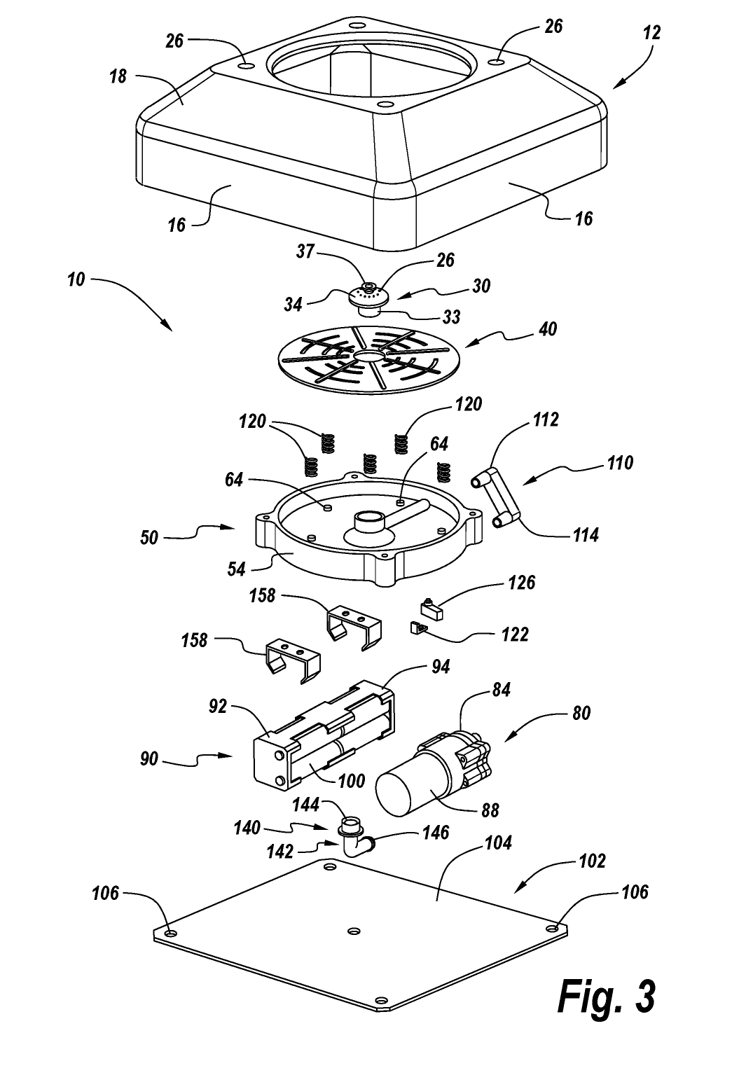

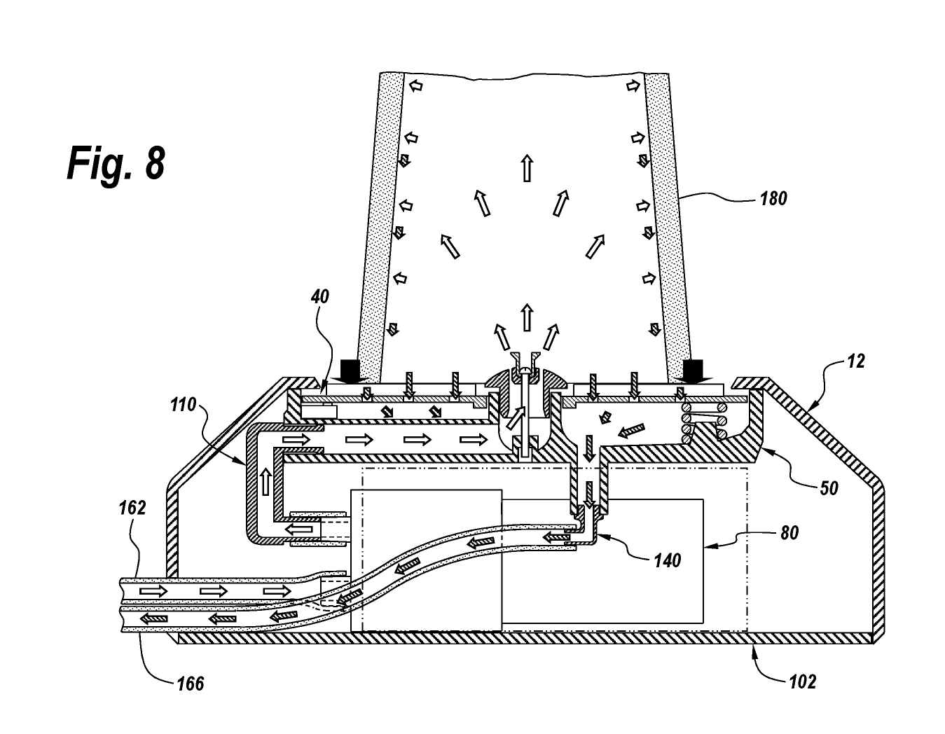

The illustrated portable fluid dispensing and rinsing system 10 further includes a nozzle assembly 30, a drain plate 40, a drain pan 50, a motor assembly 80, a battery housing 90, and a bottom lid or cover 102. As shown for example in FIGS. 3 and 7-10, the nozzle assembly 30 includes a main body 32 that has a dome shaped top surface 34 and an opposed undersurface, and an axially downwardly extending tubular extension or bottom portion 33. The top surface 34 includes a plurality of nozzles or jets 36 for spraying a selected fluid, such as water. The nozzle assembly also includes a cap element 37 that seats within a central aperture 38 of the main body 32 for receiving a fastening element, FIG. 8. The nozzle assembly functions as the rinsing element of the portable fluid dispensing and rinsing system of the present invention.

The system 10 also includes an axially movable drain plate 40. As shown in FIGS. 3, 7-8, and 10-11, the illustrated drain plate 40 includes a main body 42 that has a central aperture 44 for seating the nozzle assembly 30 and a plurality of slots 46 for allowing fluid sprayed from the nozzle assembly 30 to drain therethrough. The main body 32 of the drain plate has a top surface 48 and an opposed bottom surface 47. The drain plate 40 is resiliently and movably coupled to the drain pan 50 so that the drain plate 40 is axially movable between a non-actuated position and an actuated position, as described in further detail below.

With reference to FIGS. 3, 5 and 7-10, the illustrated drain pan 50 includes a main body 52 having a raised peripheral wall 54 forming a pan chamber 56. The pan chamber 56 has a bottom surface 58. The wall 54 has a wall opening 55 formed therein for seating a portion of a diverter element 110. The bottom surface 58 of the pan chamber 56 has coupled thereto a fluid passage, such as the covered passage 60, that fluidly couples the wall opening to a central nozzle receptacle 62. Those of ordinary skill will readily recognize that the fluid passage can a separate component coupled to the drain pan or can be integrated with the drain pan. The purpose of the fluid passage is to connect the incoming water with the nozzle assembly 30. The central nozzle receptacle 62 has a first dome-shaped housing 62A and an axially outwardly extending connection part 62B that forms a chamber 62C. The chamber 62C preferably includes an opening 62D that communicates with the covered passageway 60. The nozzle receptacle 62 seats the bottom portion 33 of the nozzle assembly for fluidly coupling the nozzle elements 36 with the covered passage 62. The bottom surface 58 of the drain pan 50 also has formed therein a plurality of stops 64 that form spring seats for seating corresponding biasing elements, such as springs 120. The stops 64 are equally spaced about the central opening 62. The bottom surface 58 also includes a switch housing 66 for mounting a switch element 126. The switch element 126 is secured within the switch housing 66 by a switch holder 132. A drain opening 68 is formed in the bottom surface 58 adjacent the central opening 62 so as to allow fluid that collects in the pan chamber 56 from draining therefrom. The drain opening 68 can have formed on the opposed second surface 70 an opening extension 68A that can be coupled to a drain connector 140. Those of ordinary skill in the art will readily recognize that the switch 126 can be mounted at any selected location within the chamber 20 of the base housing, and specifically can be coupled to the drain pan at any selected location. The illustrated drain connector 140 has a main body 142 in the shape of an elbow (e.g., L-shaped) that has a first end 144 that seats in and is fluidly coupled with the drain connector 68A, and an opposed second end 146 that is coupled to an outlet hose element 166.

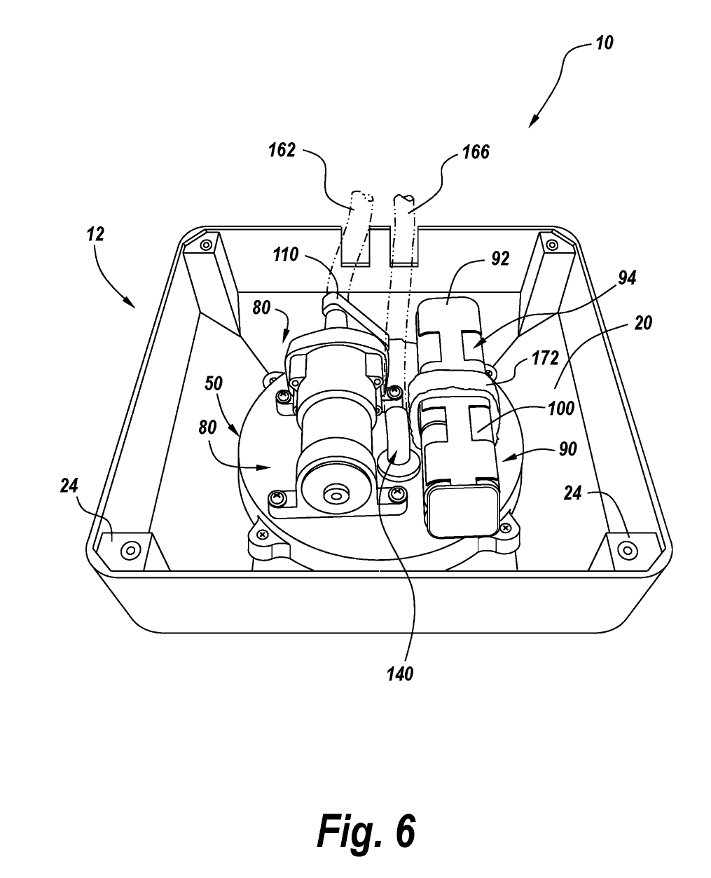

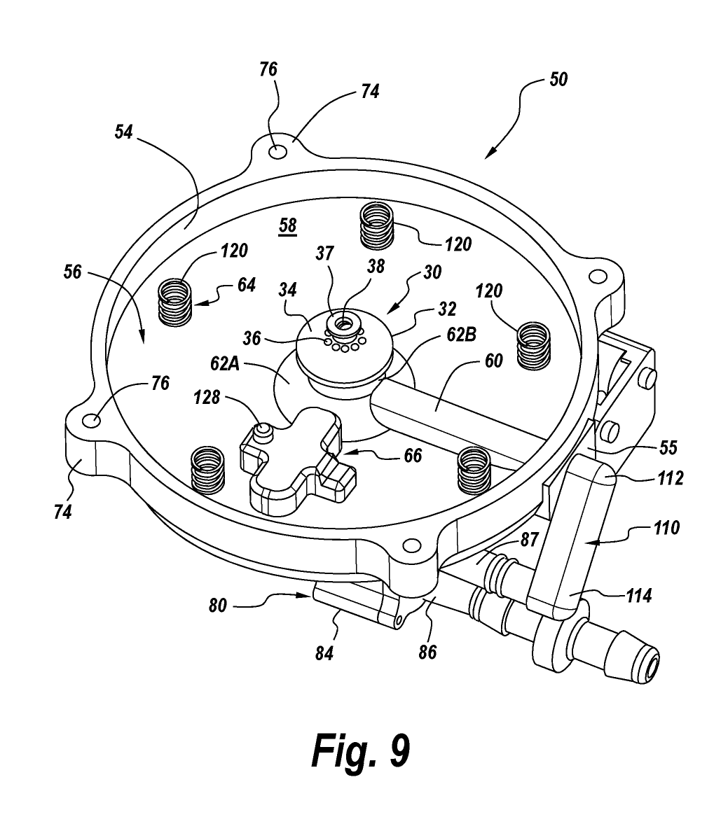

The illustrated drain pan 50 also has an opposed outer surface 70 that includes a set of fastener flanges 74 that include fastener-receiving apertures 76 for receiving the corresponding fasteners 28. The surface 70 also includes apertures 78 for mounting the bracket elements 158, 158. The surface 70 also includes a switch chamber 72 that forms the switch housing 66. The switch 126 seats within the chamber 72 and the switch holder 132 secures the switch element 126 therein. The switch housing 66 also includes an aperture formed therein for seating a movable or depressible actuator element 128 of the switch 126, FIG. 9. The brackets 158, 158 help retain the battery housing 90 to the drain pan 50. A strap 172 can also be employed to operate in conjunction with the brackets to secure the battery housing, FIG. 6. The illustrated battery housing 90 includes a main body 92 that includes a series of receptacles 94 for mounting a series of power elements, such as batteries 100. The brackets 158, 158 help mount and secure the battery housing to the surface 70 of the drain pan 50. Further, the illustrated drain pan 50 can have any selected shape or configuration, and the illustrated protrusions and structures, such as the switch housing, can be present or absent depending upon the mounting location and type of the switch.

The illustrated portable fluid dispensing and rinsing system 10 of the present invention also includes a motor assembly 80 that is also secured to the outer surface 70 of the drain pan 50 adjacent the battery housing 90 according to known techniques, FIGS. 3-4 and 6. The motor assembly 80 includes a housing 82 that includes a motor 88 at one end and a fluid coupler 84 at another end that is secured to the motor 88 by fasteners 85. The fluid coupler 84 includes an inlet port 86 and an outlet port 87. The inlet port 86 is coupled to a fluid supply source (not shown) by a suitable fluid passageway, such as by a flexible fluid conduit or passage, such as the flexible inlet hose element 162. Likewise, the outlet port 87 is coupled to a suitable fluid conduit or passage, such as by the flexible outlet hose element 164, for transporting the fluid from the fluid source through the fluid coupler 84 to the nozzle assembly 30 via the diverter 110. Specifically, the outlet port 87 is coupled to a first end 112 of the diverter 110 through the hose element 164. The opposite second end 114 of the diverter element is coupled to the wall opening 55. The wall opening is fluidly coupled to the covered passage 60 and to the nozzle receptacle 62. The motor assembly 80 thus functions as a pump transporting fluid from the fluid supply source through the diverter 110 and to the nozzle assembly 30 via the covered passage 60 and the wall opening 55.

The illustrated portable fluid dispensing and rinsing system 10 also includes a cover 102 that seats on and is fastened to the bottom of the base housing 12, FIGS. 3 and 6. The cover 102 has a main body 104 that includes a plurality of fastener receiving apertures 106 for receiving suitable fasteners, such as screws 108 that can also function as rubber feet for the system. The apertures 106 can be aligned with the aperture receptacles 24 formed in the base housing to seat the feet and thus secure the cover 102 to the base housing 12.

The portable fluid dispensing and rinsing system 10 of the present invention comes pre-assembled, but various components of the system can be generally connected as follows. The switch element 126 is seated within a switch chamber 72 of the switch housing 66. The switch housing 66 includes an aperture seating a portion of the switch element 126, such as an axially movable or depressible actuator 128 that is exposed to the chamber 56 of the drain pan 50. The switch element 126 is retained and secured within the switch chamber 72 by a switch holder 132. The battery housing 90 with associated power sources 100 (e.g., batteries) is coupled to the opposed outer surface 70 of the drain pan 50 by suitable fastening techniques. Similarly, the motor assembly 80 is coupled to the surface 70 adjacent to the battery housing 90. The battery housing 90 is electrically connected to the motor assembly 80. The motor assembly 80 in turn is electrically connected to the switch element 126.

The inlet hose element 162 is coupled to the inlet port 86 of the fluid coupler 84 of the motor assembly 80. The nozzle outlet hose element 164 is coupled to the outlet port 87 of the motor assembly 80. The diverter 110 is coupled at one end 114 to the nozzle hose element 164 and is coupled at the other end 112 to the wall opening 55. Likewise, the drain connector 140 is coupled to the drain hole 68 and to the associated extension 68A formed in the bottom surface 58 of the drain pan 50. The drain connector 140 can be secured to the drain connector by any suitable means, including by any suitable adhesive or mechanical fit. The drain outlet hose element 166 is coupled to the drain connector 140. The various components forming the fluid passages can be coupled together according to known techniques, and preferably form a fluid tight seal when coupled together.

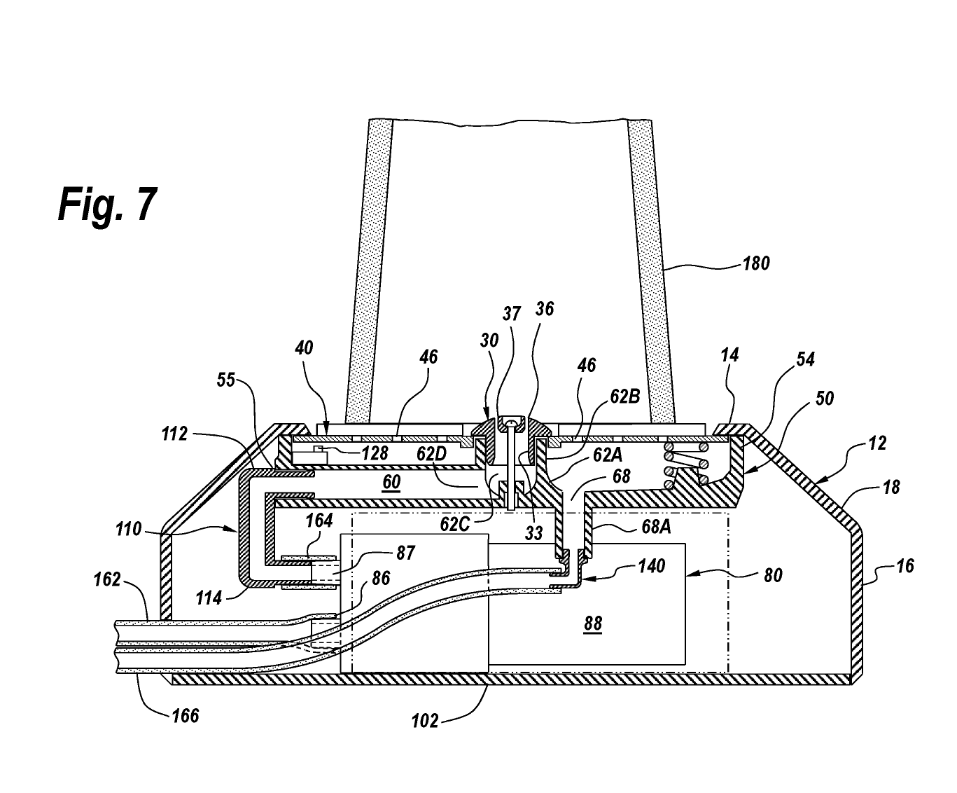

The drain pan 50 includes a series of stops 64, each of which mounts a corresponding spring 120. The main body 52 of the drain pan 50 includes a series of fastener hubs or flanges 74 that include an associated fastener receiving aperture 76. The drain pan 50 is then coupled to an underside of the top surface 14 of the base housing 12 by fasteners seated in the apertures 76. If desired, a gasket can be included between the drain pan and the base housing to create a fluid tight seal. The drain plate 40 is coupled to the drain pan 50 and is supported by the springs 120. The nozzle assembly 30 is passed through the central aperture 44 of the plate main body 42 and seats within the nozzle receptacle 62 of the drain pan 50. The cap element 37 of the nozzle assembly 30 seats a fastener for securing the nozzle assembly to the drain pan 50. The drain plate 50 is thus mounted between the nozzle assembly 30 and the springs 120. Specifically, the drain plate 40 contacts an underside of the dome shaped top surface 34 of the nozzle assembly 30. The biasing force applied by the springs 120 generally forces the drain plate 40 away from the switch housing 66 and the switch actuator 128 and towards the nozzle assembly 30, FIG. 7. When in use, the drain plate 40 can be forced axially downwardly against the force of the springs 120 by a suitable fluid receptacle, such as the glass 180 until the drain plate 40 contacts the actuator 128 of the switch 126. The axial movement of the drain plate between the non-actuated position and the actuated position determines whether the motor is activated.

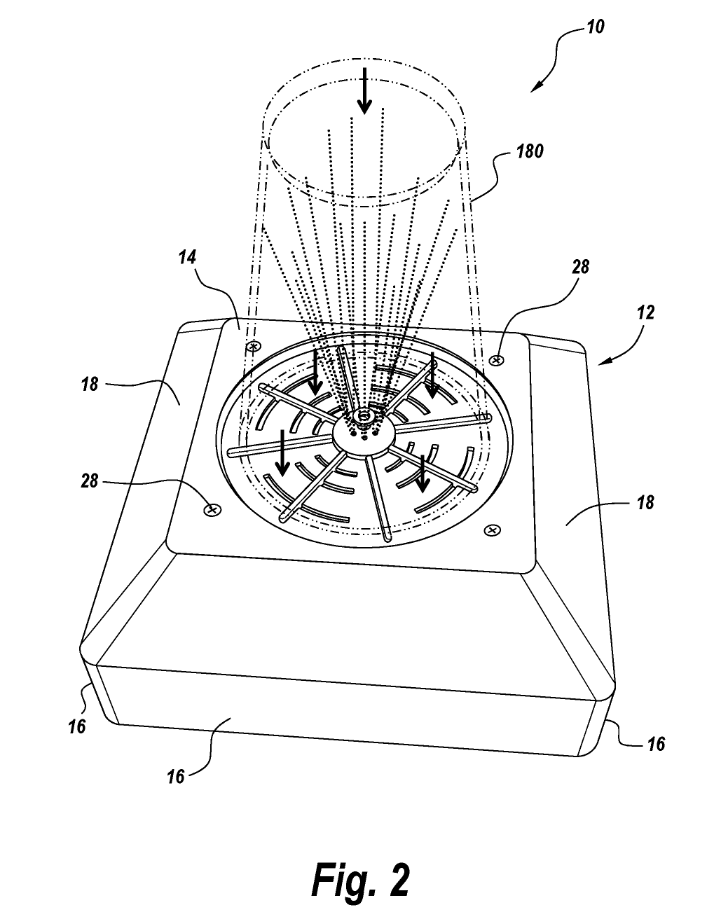

In operation, the portable fluid dispensing and rinsing system 10 of the present invention is placed or disposed at any suitable location. As shown in FIGS. 1-2 and 6-8, the inlet hose element 162 is coupled to a fluid source or supply. The fluid can be any suitable type of fluid, such as water. The drain outlet hose element 166 is coupled to a suitable drain, such as a waste water receptacle. In the normal non-actuated position, the drain plate 40 is separated from the actuator 128 of the switch element 126, FIGS. 1 and 7. When a user wishes to rinse the glass 180, the glass is placed face down on the drain plate 40 and the glass is pushed axially downwardly by the user, FIGS. 2 and 8. The drain plate 40 moves axially downwardly away from the dome-shaped top surface 34 of the nozzle assembly 30 towards the drain pan 50 until the drain plate 40 contacts the actuator 128 of the switch element 126. The actuator 128 moves axially downwardly and serves to actuate the motor assembly 80. The motor assembly 80 draws water from the fluid source into the inlet hose element 162. The inlet water then passes through the inlet port 86 of the fluid coupler 84 portion of the motor assembly 80, and then passes through the outlet port 87. The outlet port 87 is coupled via a nozzle outlet hose element 164 to the diverter 110, which in turn is coupled via the wall opening 55 to the fluid passage 60. The water thus passes from the outlet port 87 through the passage 60 and into the nozzle receptacle 62. The nozzle assembly 30 is disposed within the nozzle receptacle 62, and specifically, the bottom portion 33 of the nozzle main body 32 seats within the chamber 62C of the connection part 62B. The water is then forced through the nozzle elements 36 of the nozzle assembly 30 to form a spray that rinses the inside of the glass. As shown in FIG. 8, the clean inlet water is shown in non-dashed arrows as is moves through the complete fluid inlet passages. The rinse water passes through the slots 46 in the drain plate 40 and into the pan chamber 56 of the drain pan 50. The rinse water then passes through the drain opening 68 and into the outlet hose element 166. The waste water can be, if desired, collected in a waste water receptacle. As also shown in FIG. 8, the rinse water fluid pathways is shown in hashed arrows.

When the user deems the rinsing operation to be complete, the user then releases the downward force on the glass 180. The springs 120 mounted on the stops 64 of the bottom surface 58 of the drain pan then force the drain plate 40 axially upwardly away from the actuator 128. The release of the drain plate 140 thus serves to shut off the motor, which stops the supply of water to the nozzle assembly 30.

Those of ordinary skill in the art will readily recognize that the diverter element 110 and the drain connector 140 can have any selected shape or configuration and can be a unitary piece or can comprise multiple connectable components. The components need only be able to form a fluid passage for the passage of fluid in a fluid tight manner. Further, those of ordinary skill in the art will readily recognize that additional or various other fluid connectors can be employed along the various fluid pathways so as to mechanically and fluidly couple together the components of the illustrated portable fluid dispensing and rinsing system.

According to the present invention, the portable fluid dispensing and rinsing system 10 includes a base portion that mounts a depressible or axially movable drain plate structure. A motor assembly is employed to help pump or drive fluid from one source or location to another. A power source, such as batteries, is also provided to help power the motor assembly. The motor assembly and the power source can be coupled to one side of a drain pan. The drain pan has a drain hole formed therein. The drain plate and a series of springs can be mounted to the other side of the drain pan. The drain plate is adapted to seat on the springs to allow for axially movement thereof. A nozzle element can be coupled to the drain plate and the drain hole. This combination of elements forms a drain and pump assembly.

The drain and pump assembly is mounted to an underside of the base structure via any suitable fastening mechanism. A series of fluid conduits, such as hoses, can be coupled to the drain and pump assembly. Specifically, a supply conduit can be coupled to the pump for fluidly coupling a fluid source to the nozzle, and a drain conduit can be fluidly coupled to the drain hole for coupling a waste fluid receptacle to the mounting bracket.

According to a second embodiment, the base housing or structure of the first embodiment can be replaced with a box type base structure that includes a top or lid portion that has an aperture formed therein that is adapted to mount the drain and pump assembly. The chamber formed therein can be employed to mount a fluid source, such as a first fluid bladder, and a waste receptacle, such as a second fluid bladder. When mounted as such, the fluid dispensing device of the present invention can be used as a portable, self contained fluid rinser.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

Having described the invention, what is claimed as new and desired to be secured by Letters Patent is:

We claim:

1. A portable fluid rinsing system, comprising
a base housing having a plurality of sides and forming an inner chamber, wherein a top surface of the base housing has an opening formed therein,
a drain pan mounted to the base housing and disposed within the inner chamber, the drain pan having a first surface with an outwardly extending circumferential wall formed thereabout forming a drain pan chamber and an opposed second surface, the circumferential wall having formed therein a wall opening, wherein the first surface has further formed thereon
a nozzle receptacle formed in a generally central location,
a fluid passage that is disposed between and is fluidly coupled to the wall opening and to the nozzle receptacle,
a plurality of stops protruding outwardly therefrom, each of said plurality of stops is configured for seating a biasing member, and
a drain opening,
a switch element coupled to the drain pan,
a battery housing coupled to the second surface of the drain pan,
a motor assembly coupled to the second surface of the drain pan adjacent the battery housing and electrically coupled to the battery housing and to the switch element,
a drain plate disposed within the opening in the top surface of the base housing and having a central opening, and
a nozzle assembly sized and configured for passing through the central opening of the drain plate and for seating in the central receptacle of the drain pan, the nozzle assembly having a plurality of nozzle elements formed therein, wherein the nozzle elements are fluidly coupled to the central receptacle, the fluid passage, and the wall opening.

2. The portable rinsing system of claim 1, further comprising a switch housing protruding outwardly from the first surface of the drain pan and having an aperture formed therein, and wherein the switch element includes an actuator that extends through the aperture in the switch housing.

3. The portable rinsing system of claim 1, wherein the switch element includes an actuator, extending outwardly therefrom.

4. The portable rinsing system of claim 3, wherein the drain plate is movable in an axial direction between a non-actuated position where the drain plate is separated from the actuator and an actuated position where the drain plate contacts and engages the actuator.

5. The portable rinsing system of claim 4, wherein when the drain plate is disposed in the actuated position, the motor assembly is actuated.

6. The portable rinsing system of claim 1, wherein the motor assembly includes a motor element and a fluid coupler having an inlet port and an outlet port.

7. The portable rinsing system of claim 6, further comprising a drain connector coupled to the drain opening formed in the drain pan, and a fluid diverter fluidly coupled to the wall opening and to the outlet port of the motor assembly.

8. The portable rinsing system of claim 7, wherein the drain connector has an elbow shape.

9. The portable rinsing system of claim 7, further comprising a first fluid conduit coupled to the inlet port of the motor assembly, and a second fluid conduit coupled to the drain connector for draining fluid in the drain pan chamber.

10. The portable rinsing system of claim 9, further comprising a third fluid conduit having one end coupled to the outlet port of the motor assembly and an opposed end coupled to the fluid diverter.

11. The portable rinsing system of claim 9, wherein the drain plate is movable in an axial direction between a non-actuated position where the drain plate is separated from the switch element disposed in the switch housing and an actuated position where the drain plate contacts and engages the switch element.

12. The portable rinsing system of claim 11, wherein when the drain plate is disposed in the actuated position, the motor assembly is actuated and fluid from a fluid source is conveyed through the inlet port of the motor assembly, passes through the outlet port of the motor assembly, passes through the fluid diverter and into the nozzle receptacle via the wall opening and the covered passage, and through the nozzle assembly.
